(19) United States
(12) Patent Application Publication
(10) Pub. No.: US 2019/0289948 A1
(43) Pub. Date: Sep. 26, 2019

(54) HAT WITH INTERCHANGEABLE AND FULLY ADJUSTABLE CLOSURE BANDS

(71) Applicant: Lionel Moroy, Vista, CA (US)

(72) Inventor: Lionel Moroy, Vista, CA (US)

(21) Appl. No.: 15/926,704

(22) Filed: Mar. 20, 2018

(51) Int. Cl. A42B 1/20; A42B 1/22; A42B 1/00; A42B 7/00; G09F 21/02

(52) U.S. Cl. CPC A42B 1/206; A42B 1/22; G09F 21/026; A42B 7/00; A42B 1/004

(57) ABSTRACT

A hat having a closure band which is removably attached to the hat is disclosed. The hat may have a sweatband that is sewn in place to the perimeter portion of the hat along the bottom of the perimeter portion as well as at a distance above the bottom portion to create a loop aperture. The sweatband and the closure band may have adjustable fastening devices such as a hook and loop material (e.g., Velcro®). The closure band may be removably attached to the hat by adjusting the length to accommodate the circumference of a wearer's head, and may be removable attached onto the hook and loop material on the sweatband. Hence, a wearer may remove and replace the closure band with another closure band having a different color, logo, or material to show support for another sports team.

### BACKGROUND OF THE INVENTION

### 1. Field of the Invention

The present invention relates in general to hats. More particularly, the invention is directed to hats, such as caps, visors, etc., having closure bands.

### 2. Description of the Related Art

Hats having closure bands that allow for hat size adjustment are very popular and are worn by people throughout the world. Some hats have crowns (e.g. caps) and some do not (e.g. visors). In either case, such hats often have distinctive colors or logos or other indicia for identifying a person's support for something such as a home country, a sports team or a company. Some hats have logos placed on the closure bands. However, most, if not all conventional hats have closure bands that are somewhat unattractive because they have visible connection features such as bulky buckles or overlapping plastic straps with a row of visible snaps and holes (aka “snapbacks”). In addition, most, if not all conventional hats have closure bands which are permanently affixed to at least one side of the hat, so wearers have to purchase additional hats to have a different closure band, e.g. to have a closure band with a new contrasting color or to show their support for other teams or companies. Moreover, conventional hats do not allow closure bands with logos to be re-positioned and centered with respect to the hat.

According, a need exists for providing a hat with interchangeable and fully adjustable closure bands having hidden adjustments on both ends.

### SUMMARY OF THE INVENTION

In the first aspect, a hat is disclosed. The hat comprises a hat body comprising a perimeter portion having a lower edge adapted to partially encircle a head of a wearer above the eyes of the wearer, the perimeter portion defining an opening on the back portion of the perimeter portion, and a sweatband positioned in the lower interior of the perimeter portion, the sweatband is attached to the perimeter portion near the lower edge of the perimeter portion and at a first distance from the lower edge of the perimeter portion forming two loop apertures on opposite sides of the opening of the perimeter portion. The hat body further comprises two first-type fastening devices affixed to the surface of the sweatband immediately adjacent to the perimeter portion, each of the two first-type fastening devices positioned on opposite sides of the opening of the perimeter portion.

The hat further comprises a closure band shaped as an elongated rectangle having a first end and a second end opposite the first end along the length of the closure band, the closure band having a width sized to be received within the loop apertures of the hat body, the closure band having a front surface and a back surface which receives the head of a wearer, and two second-type fastening devices attached the closure band, one of the two second-type fastening devices attached to a first end of the closure band, and the other second-type fastening device attached to the second end of the closure band. The closure band is removably attached to the hat body when the first-type fastening devices are mated with the second-type fastening devices, the closure band configured to be laterally adjustable with respect to the opening of the perimeter portion and to be separable from the hat body.

In a first preferred embodiment, a logo is placed on the closure band. The two second-type fastening devices are preferably affixed to the front surface of closure band. The closure band further preferably comprises a third and fourth second-type fastening devices attached to the closure band on the side opposite the two second-type fastening devices. The hat body preferably further comprises two eyelets each configured to attached to the loop aperture of the hat body and receive the closure band. The first-type and second-type fastening devices preferably comprise hook and loop fasteners. The first-type and second-type fastening devices preferably comprise clip fasteners. The closure band is preferably fabricated from stretchable material. The hat preferably further comprises a second closure band sized to be received within the loop apertures of the hat body, and two additional second-type fastening devices attached to the second closure band, one of the two additional second-type fastening devices attached to a first end of the second closure band, and the other additional second-type fastening device attached to a second end of the second closure band. The second closure band is removably attached to the hat body and is interchangeable with respect to the closure band. The perimeter portion comprises a crown for a cap.

In a second aspect, a hat is disclosed. The hat comprises a hat body comprising a perimeter portion having a lower edge adapted to partially encircle a head of a wearer above the eyes of the wearer, the perimeter portion, the perimeter portion defining an opening on the back portion of the perimeter portion, and a sweatband positioned in the lower interior perimeter portion, the sweatband attached to the perimeter portion near the lower edge of the perimeter portion and at a first distance from the lower edge of the perimeter portion forming two loop apertures on opposite sides of the opening of the perimeter portion. The hat body further comprises two first-type fastening devices positioned on opposite sides of the opening of the perimeter portion. The hat further comprises a closure band shaped as an elongated rectangle having a first end and a second end opposite the first end along the length of the closure band, the closure band having a width sized to be received within the loop aperture of the hat body, and two second-type fastening devices attached the closure band, one of the two second-type fastening devices attached to a first end of the closure band, and the other second-type fastening device attached to the second end of the closure band. The closure band is removably attached to the hat body when the first-type fastening devices are mated with the second-type fastening devices, the closure band configured to be laterally adjustable with respect to the opening of the perimeter portion and to be separable from the hat body.

In a second preferred embodiment, a logo is placed on the closure band. The closure band further preferably comprises a third and fourth second-type fastening devices attached to the closure band on the side opposite the two second-type fastening devices.

The hat body further preferably comprises two eyelets each configured to attached to the loop aperture of the hat body and receive the closure band. The first-type and second-type fastening devices preferably comprise hook and loop fasteners. The first-type and second-type fastening devices preferably comprise clip fasteners. The closure band is preferably fabricated from stretchable material. The hat preferably further comprises a second closure band sized to be received within the loop apertures of the hat body, and two additional second-type fastening devices attached to the second closure band, one of the two additional second-type fastening devices attached to a first end of the second closure band, and the other additional second-type fastening device attached to a second end of the second closure band. The second closure band is removably attached to the hat body and is interchangeable with respect to the closure band.

In a third aspect, a hat is disclosed. The hat comprises a hat body comprising: a perimeter portion having a lower edge adapted to partially encircle a head of a wearer above the eyes of the wearer, the perimeter portion defining an opening on the back portion of the perimeter portion, two loop apertures formed in the perimeter portion on opposite sides of the opening of the perimeter portion, and two first-type fastening devices positioned in the interior of the perimeter portion positioned on opposite sides of the opening of the perimeter portion. The hat further comprises a closure band shaped as an elongated rectangle having a first end and a second end opposite the first end along the length of the closure band, the closure band having a width sized to be received within the loop apertures of the perimeter portion, and two second-type fastening devices attached the closure band, one of the two second-type fastening devices attached to a first end of the closure band, and the other second-type fastening device attached to the second end of the closure band. The closure band is removably attached to the hat body when the first-type fastening devices are mated with the second-type fastening devices, the closure band configured to be laterally adjustable with respect to the opening of the hat body and to be separable from the hat body.

In a third preferred embodiment, a logo is placed on the closure band. The closure band preferably further comprises a third and fourth second-type fastening devices attached to the closure band on the side opposite the two second-type fastening devices. The hat body further preferably comprises two eyelets each configured to attached to the loop aperture of the hat body and receive the closure band. The first-type and second-type fastening devices preferably comprise hook and loop fasteners. The hat preferably further comprises a second closure band sized to be received within the loop apertures of the hat body, and two additional second-type fastening devices attached to the second closure band, one of the two additional second-type fastening devices attached to a first end of the second closure band, and the other additional second-type fastening device attached to a second end of the second closure band. The second closure band is removably attached to the hat body and is interchangeable with respect to the closure band.

These and other features and advantages of the invention will become more apparent with a description of preferred embodiments in reference to the associated drawings.

### DESCRIPTION OF THE DRAWINGS

FIG. 1 is a rear view of a hat shaped as a baseball cap in one or more embodiments.

FIG. 2 is a rear view of a baseball cap illustrating that the closure bands are interchangeable.

FIG. 3 is a rear view of a baseball cap illustrating that each end of the closure band is individually adjustable so that the logo on the closure band is centered with respect to the baseball cap.

FIG. 4 is a bottom view of the interior of a baseball cap in an embodiment.

FIG. 5 depicts top views of the closure bands illustrating that each closure band may have one or two logos or designs.

FIG. 6 is a bottom view of a baseball cap.

FIG. 7 is a rear view of a baseball cap illustrating various forms of fastening devices.

FIG. 8 is a side view of a hat shaped as a visor cap.

FIG. 9 is a rear view of a visor cap in one or more embodiments.

FIGS. 10A and 10B are front and side views respectively of the loop aperture.

FIG. 11A is a rear view of a visor cap having eyelets.

FIG. 11B is a partial view of the visor cap showing details of the eyelet.

FIG. 12A is a rear view of a visor cap having stitched loop apertures.

FIG. 12B is a partial view of the visor cap showing details of the loop aperture.

### DETAILED DESCRIPTION OF THE PREFERRED EMBODIMENTS

Hats, including baseball caps and visor or golf caps, are worn by people throughout the world, and are usually stylized with colors or logos or other indicia that are associated with sports teams or companies. Logos may be placed on the front portion of a hat, or may be placed on the rear portion of the hat such as on the closure band for example. Conventional hats may employ closure bands which usually are permanently affixed to the hats, so wearers of hats must purchase additional hats if they want to show their support for other sports teams. Moreover, conventional closure bands may not always be centered with respect to the hat.

In one or more embodiments, a hat having a closure band which is removably attached to the hat is contemplated. While embodiments of hats described herein may include hats with crowns such as baseball caps, and hats without crowns such as visor or golf caps, it shall be understood that these embodiments are for illustration purposes only and shall not be deemed limiting. Other forms of hats having closure bands are contemplated in one or more embodiments including ascot caps, beanies, berets, and half hats, and others, for example.

In an exemplary embodiment, a hat in the form of a baseball cap may have a sweatband that is sewn in place to the crown along the bottom of the crown as well as at a distance above the bottom portion to create a loop aperture. The sweatband may have an adjustable fastening device such as a hook and loop material (e.g., Velcro®) sewn onto the sweatband. The closure band may have the corresponding hook and loop material sewn into the ends of the closure band. The closure band may be removably attached to the baseball cap by adjusting the length to accommodate the circumference of a wearer's head, and may be removably attached onto the hook and loop material on the sweatband. Hence, a wearer may remove and replace the closure band with another closure band having a different color, logo, or material to show support for another sports team. Moreover, the wearer can adjust the closure band so that the logo or design is centered with respect to the baseball cap.

The closure band may be fabricated with either elastic or non-elastic material. In a preferred embodiment, the hook and loop material is sewn into the sweatband so that stitching would not be visible on the outside of the hat. In an embodiment, metal eyelets may be placed on the loop apertures to reinforce the durability of the loop apertures. Several types of fastening devices may be employed including hook and loop fasteners (e.g., Velcro®), clips or buttons, or buttons affixed to an elastic band.

In one or more embodiments, the wearer is able to adjust the position and length on a millimeter scale of the closure band by employing a simple Velcro® system. This may be used to enhance branding and marketing applications for hats. In an embodiment, the adjustable closure band system may provide a technologically advanced appearance and may provide a means to use different materials on the hat. In a preferred embodiment, the closure bands may be wider than conventional closure bands and may be fabricated from a comfortable anti-allergenic material. Embodiments provide an improved appearance with a simple system to hide the closure or hat adjustment.

In one or more embodiments, the hat with the removable closure band enables a wearer to adjust both the left side and the right side of the closure band as attached to the hat. The hoop and loop attachment mechanism is inside the hat, so there is no visible closure system employed such as a plastic clip or metal buckle to adjust and close the hat. Using embodiments of the hat with removable closure bands is simple. First, a wearer slides the closure band into the hat through the two loop apertures. Second, the wearer sets the position of the closure band. And third, the Velcro® holds the closure band in place on the hat.

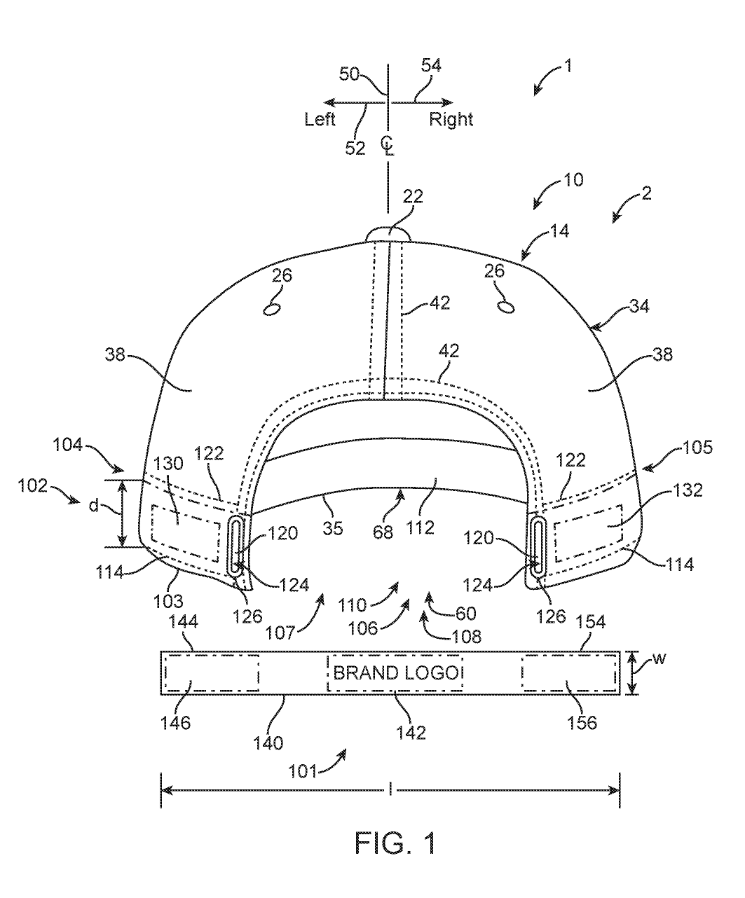

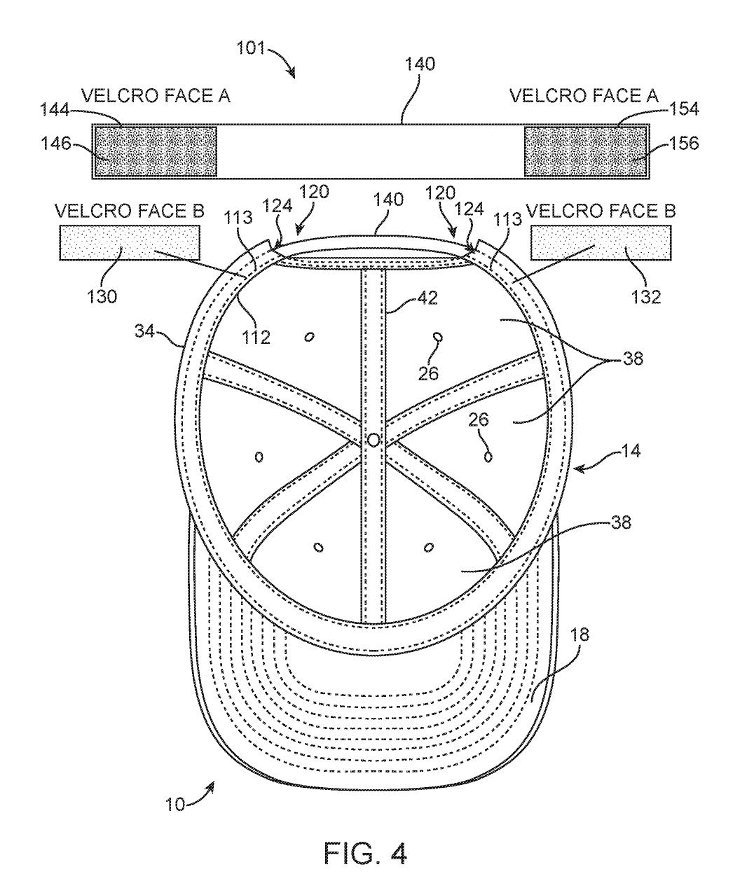

FIG. 1 is a rear view of a baseball cap 10 (i.e. hat 1) in one or more embodiments. The baseball cap 10 has a crown 34 (i.e. perimeter portion 102 having a lower edge 103 adapted to partially encircle a head of a wearer above the eyes of the wearer) that is made out of several panels 38 which are sized and stitched 42 together to form a generally hemispherical shape that is contoured to fit on the head of a wearer. The baseball cap 10 has a visor 18 (see FIG. 4) for blocking the sun from the eyes of the wearer, a plurality of eyelets 26, and a button 22 at the top of the cap 10. A center-line 50 of the cap 10 depicts a left-hand side 52 and a right-hand side 54.

In an embodiment, the cap 10 has a closure apparatus 101 comprising first-type fastening devices 130 and 132 affixed to the interior 68 of the cap body 14, and a removable closure band 140 having second-type fastening devices 146 and 156. As used herein, the terms “first-type fastening devices” and “second-type fastening devices” refer to fastener systems where the first-type fastening devices can secure the second type fastening device without tools, and where the first-type fastening devices 130 and 132 and second-type fastening device 146 and 156 can be separated by manually pulling the fastening devices apart. Examples of these types of fastening systems include, but are not limited to, hook and loop fasteners (Velcro®), clips, a strip having buttons and button holes, and types of fasteners that can be secured and detached without tools. The terms “fastening device” and “fastener” may be used interchangeably herein. A wearer can independently adjust the left-side 144 and the right-side 154 of the closure band 140, separate from one another, so that a logo 142 may be re-positioned and properly centered with respect to the cap 10. Moreover, a wearer can detach the closure band 140 from the cap 10 by simply undoing the fastening devices on the left- and right-sides of the cap 10.

In an embodiment, the cap 10 comprises a cap body 14 (i.e. hat body 2) including a crown 34 defining an opening 110 (i.e. opening of perimeter portion 106) on the back portion (i.e. back of perimeter portion 107) of the crown 34. The cap body 10 further comprises a sweatband 112 positioned in the lower interior 68 (i.e. interior of the perimeter portion 108) along the bottom perimeter 35 of the crown. The sweatband 112 is attached to the crown 34 near the bottom portion of the crown 35 and at a first distance “d” 122 from the bottom portion of the crown 35 forming a loop aperture 120. Two first-type fastening devices 130 and 132 such as Velcro® hook and loop fasteners are affixed to the surface of the sweatband 112 immediately adjacent to the crown 113, each of the two first-type fastening devices 130 and 132 are positioned on opposite sides of the opening 110 of the crown 34. As shown in FIG. 1, one of the first-type fasters 130 is positioned to the left of the opening 110, and the other first-type fastening device 132 is positioned to the right of the opening 110.

The cap 10 further comprises a closure band 140 shaped as an elongated rectangle having a first end 144 and a second end 154 opposite the first end along the length “I” of the closure band 140. As shown, the first end 144 is on the left hand side of the closure band 140 and the second end 154 is on the right hand side of the closure band 140.

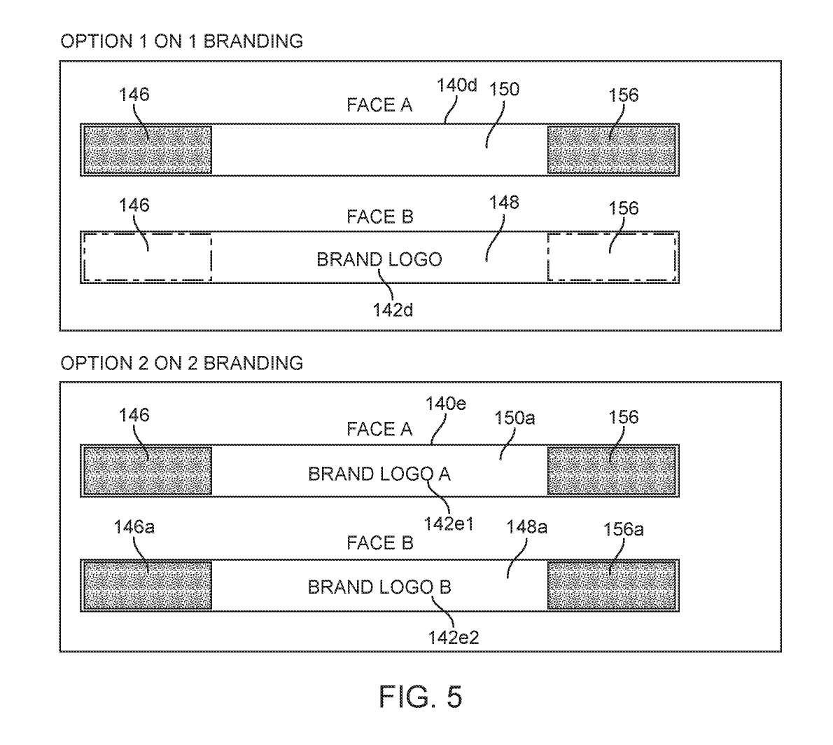

The closure band 140 has a width “w” sized to be received within the loop aperture 120 of the cap body 14. In other words, the width “w” of the closure band is less than the first distance 122 “d” of the loop aperture 120 on the cap 10. As shown most clearly in FIG. 5, the closure band 140 has a front surface 148 and a back surface 150 which receives the head of a wearer. In an embodiment, two second-type fastening devices 146 and 156 are attached the closure band 140. In an embodiment, the first-type and second-type fastening devices 130, 132, 146, and 156 may comprise a hook and loop system. One second-type fastening device 146 of the two second-type fastening devices attached to a first end of the closure band 144 (shown as being on the left hand side) and the other second-type fastening device 154 is attached to the second end of the closure band (shown as being on the right hand side).

The closure band 140 is removably attached to the cap body 14 when the first-type fastening devices 130 and 132 are mated with the second-type fastening devices 146 and 156. The closure band 140 is configured to be laterally adjustable with respect to the opening of the crown 110 and to be separable from the cap body 14.

As shown, a logo 142 or other stylized design may be placed on the closure band 140. As shown most clearly in FIG. 5, the two second-type fastening devices 146 and 156 are affixed to the front surface of closure band 148. In an embodiment, the closure band 140 may be reversible having a different logo or design on the front surface 148 and 150. As shown in FIG. 5, the closure band 140 further comprises a third and fourth 146a and 156a second-type fastening devices attached to the closure band 140 on the side 148 opposite the two second-type fastening devices 146 and 156.

In a preferred embodiment, the cap body 14 further comprises two eyelets 126 each configured to attached to the loop aperture 120 of the cap body 14 and receive the closure band 140. Several types of first-type and second-type fastening devices are contemplated, including hook and loop fasteners (e.g., Velcro®), clip fasteners, as well as elastic bands couple to a button. The closure band 140 may be fabricated from stretchable material.

In another embodiment, a cap 10 comprises a cap body 14 having a crown 34 defining an opening 110 on the back portion 60 of the crown 34, a sweatband 140 positioned in the lower interior 68 along the bottom perimeter 35 of the crown 34. The sweatband 140 is attached to the crown 34 near the bottom portion 35 of the crown and at a first distance “d” from the bottom portion 35 of the crown forming a loop aperture 120. The cap body 14 also has two first-type fastening devices 130 and 132 positioned on opposite sides of the opening 110 of the crown 34.

The cap 10 further comprises a closure band 140 shaped as an elongated rectangle having a first end 144 and a second end 154 opposite the first end 144 along the length “I” of the closure band 140. The closure band 140 having a width “w” sized to be received within the loop aperture 120 of the cap body 14. The closure band 140 has two second-type fastening devices 146 and 156 attached to the closure band 140, where one of the two second-type fastening devices 146 is attached to a first end 144 of the closure band 140, and the other second-type fastening device 156 is attached to the second end 154 of the closure band 140.

The closure band 140 is removably attached to the cap body 14 when the first-type fastening devices 130 and 132 are mated with the second-type fastening devices 146 and 156. The closure band 140 is configured to be laterally adjustable with respect to the opening 110 of the crown 140 and to be separable from the cap body 14.

In another embodiment, a cap 10 comprises a cap body 14 having a crown 34 defining an opening 110 on the back portion 60 of the crown 34, and two loop apertures 120 formed in the crown 34 on opposite sides of the opening 110 of the crown 34. The cap body 14 has two first-type fastening devices 130 and 132 positioned in the interior 68 of the crown 34 and are positioned on opposite sides of the opening 110 of the crown 34.

The cap 10 further comprises a closure band 140 shaped as an elongated rectangle having a first end 144 and a second end 154 opposite the first end 144 along the length “I” of the closure band 140. The closure band 140 has a width “w” sized to be received within the loop apertures 120 of the crown 34. The closure band 140 has two second-type fastening devices 146 and 156 attached to the closure band 140, one 146 of the two second-type fastening devices attached to a first end 144 of the closure band, and the other second-type fastening device 156 attached to the second end 154 of the closure band 34. The closure band 140 is removably attached to the cap body 14 when the first-type fastening devices 130 and 132 are mated with the second-type fastening devices 146 and 156. The closure band 140 is configured to be laterally adjustable with respect to the opening 110 of the cap body 14 and to be separable from the cap body 14.

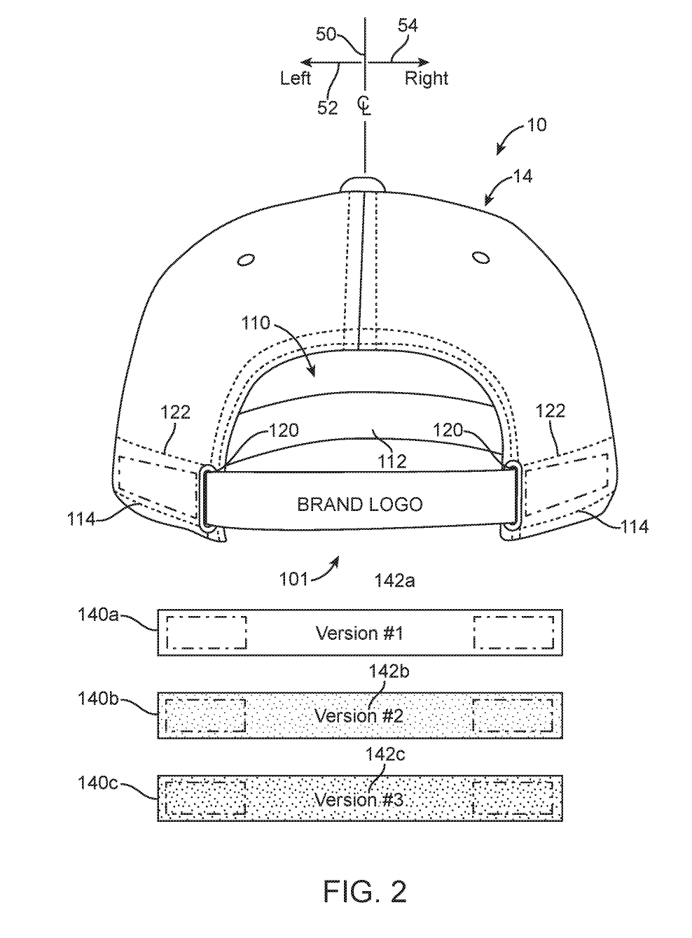

FIG. 2 is a rear view of a baseball cap 10 illustrating that the closure bands 140 are interchangeable. Closure band 140a may have a first logo 142a labeled as “Version #1,” closure band 140b may have another logo 142b labeled as “Version #2,” and closure band 140c may have a third logo 142c labeled as “Version #3.” The closure bands 140a-140c may be made with a variety of materials including cloth, elastic material, and leather for example, and may be dyed or stylized with a design or logo.

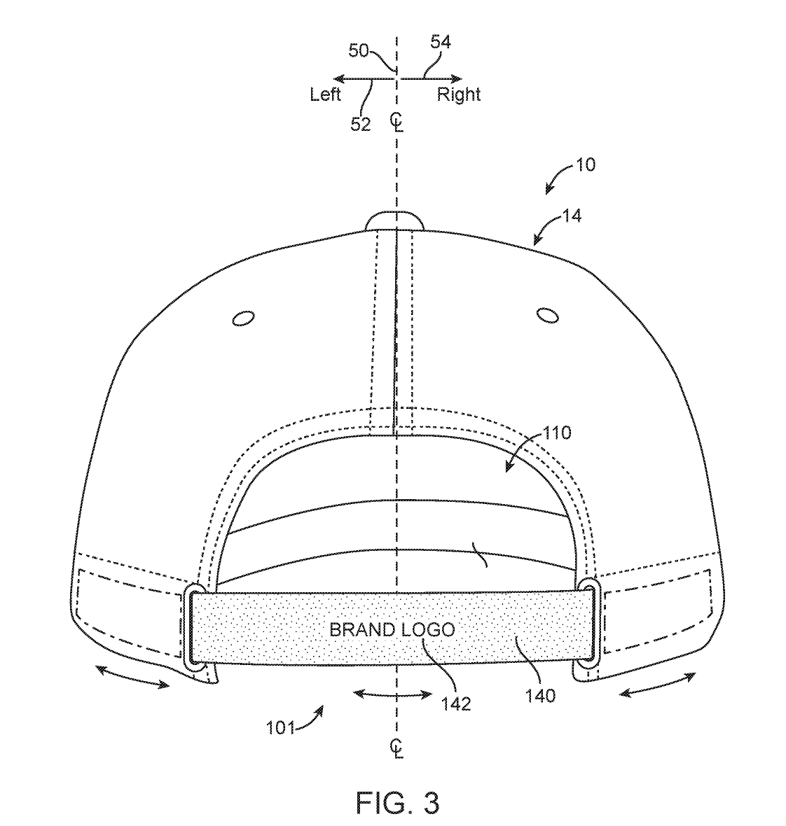

FIG. 3 is a rear view of a baseball cap 10 illustrating that the each end of the closure band 140 is individually adjustable so that the logo 142 on the closure band 140 is centered with respect to the baseball cap.

FIG. 4 is a bottom, cross-sectional view of the interior of a baseball cap 10 in an embodiment. FIG. 4 shows that a cavity or channel 124 is formed between the inner part of the crown 34 and the sweatband 120. The “Face A” fasteners 146 and 156 of the Velcro® are attached to the closure band 140 as described above. The “Face B” fasteners 130 and 132 of the Velcro® are affixed to the surface 113 of the sweatband 112 that is immediately adjacent to the crown 34. The closure band 34 enters into the cavity 124 when passing through the loop aperture 120, and the “Face A” fasteners 146 and 156 attach to the “Face B” fasteners 130 and 132 which secures the closure band 140 in place. The wearer can easily remove or readjust the closure band 140 by separating the “Face A” fasteners 146 and 156 from the “Face B” fasteners.

FIG. 5 depict are top views of the closure bands 140 illustrating that each closure band may have one or two logos or designs. For the “Option 1 on 1 Branding” illustrated at the top of FIG. 5, second-type fasteners 146 and 156 are affixed to the back surface 150 of the closure band 140d, and a logo 142d is placed on the from surface 148 of the closure band 140d.

For the “Option 2 on 2 Branding” illustrated at the bottom of FIG. 5, second-type fasteners 146 and 156 are affixed to the back surface 150a of the closure band 140e, and a third and fourth second-type fasteners 146a and 156a are attached to the front surface 148a. The front surface 148e of the closure band 140e has a logo 142e2, and the back surface 150a has a logo 142e1. Hence, a wearer is able to switch the appearance of his closure band 140e by reversing the closure band 140e to expose the opposite side.

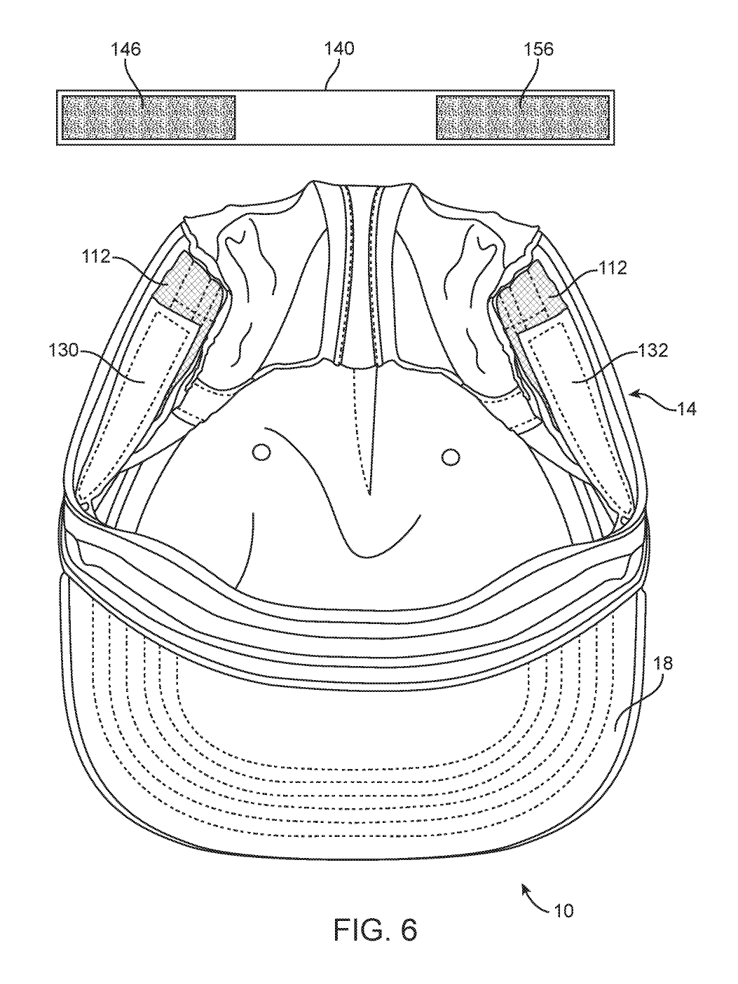

FIG. 6 is a bottom view of a baseball cap 10 showing the second-type fastening devices 130 and 132 sewn to the sweatband 112. Closure band 140 has first-type fastening devices 146 and 156 which engage with the second-type fastening devices 130 and 132.

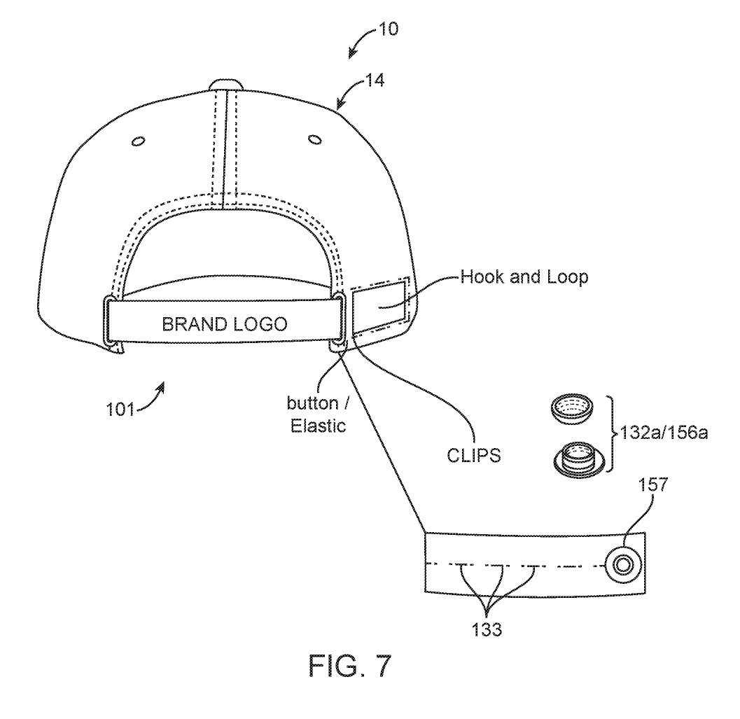

FIG. 7 is a rear view of a baseball cap illustrating various forms of fastening devices. As discussed above, a hook and loop fasteners such as Velcro® enables wearers to precisely position the closure band 140 in the cap 10. Other types of fastening devices are contemplated in one or more embodiments including clips 132a/156a and elastic bands having a button 157 and a series of button holes 133 which may engage with a button sewn into the cap.

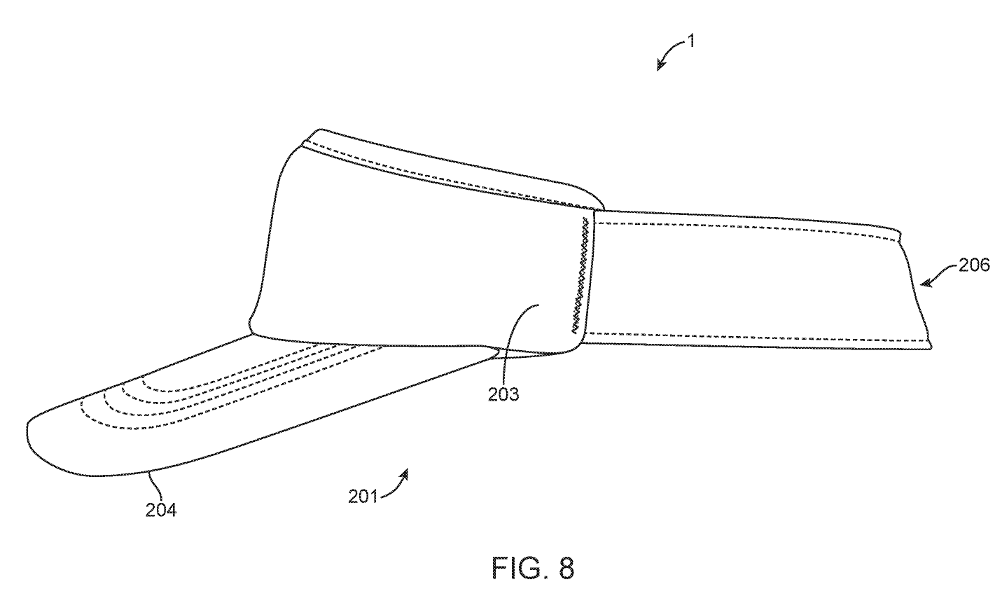

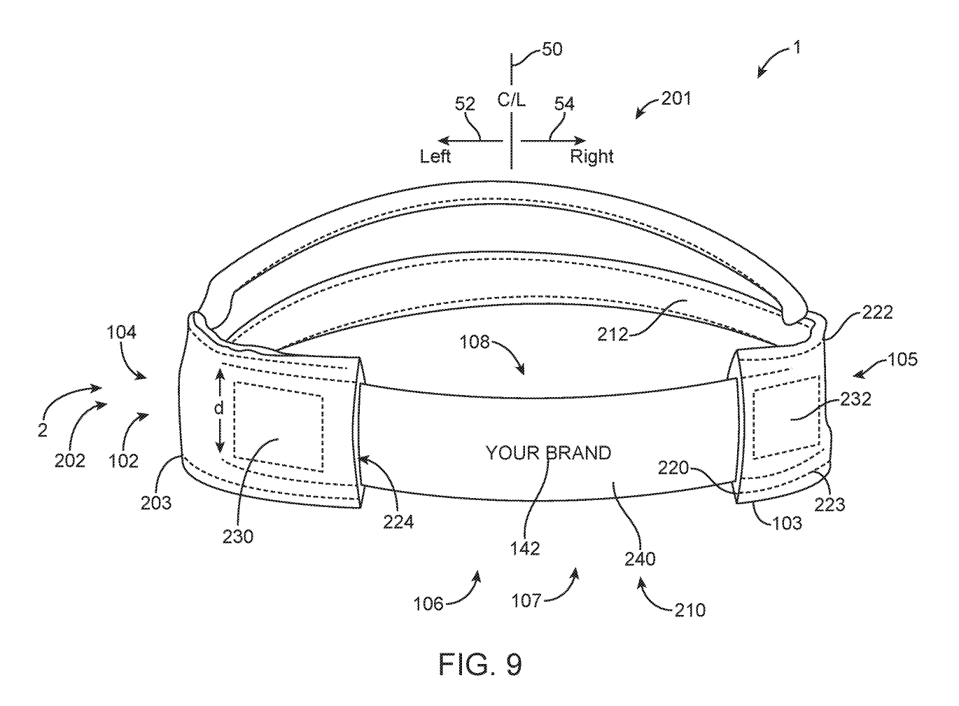

FIGS. 8 and 9 are side view and rear views respectively of a hat in the form of a visor cap 201 (i.e. hat 1) in one or more embodiments. The visor cap 201 has an outer band of material 203 (i.e. perimeter portion 102) where the lower edge 103 of the outer band of material 203 is adapted to partially encircle a head of a wearer above the eyes of the wearer. The outer band of material 203 defines an opening 210 (i.e. opening of the perimeter portion 106 on the back portion of the perimeter portion 107). In one or more embodiments, the outer band of material 203 may not cover the upper portions or scalp of the wearer. A center-line 50 of the cap 10 depicts a left-hand side 52 and a right-hand side 54, defining a left side 104 and a right side 105 of the outer band of material 203.

A sweatband 212 is positioned in the lower interior 108 of the outer band of material 203. The sweatband 212 is stitched 223 or otherwise attached to the outer band of material 203 near the lower edge 103 of the outer band of material 203. The sweatband 212 is stitched 222 or otherwise attached to the outer band of material 203 at a first distance (“d”) from the lower edge 103 of outer band of material 203 forming two loop apertures 220 on opposite sides of the opening 210 of the outer band of material 203.

Two first-type fastening devices 230 and 232 are affixed to the surface of the sweatband 212 immediately adjacent to the outer band of material 203. Each of the two first-type fastening devices 230 and 2332 are positioned on opposite sides of the opening 210 of the outer band of material 203.

A closure band 240 is shaped as an elongated rectangle having a first end and a second end opposite the first end along the length of the closure band 240. The closure band 240 has a width sized to be received within the loop apertures 220 of the hat body 2. The closure band 240 has a front surface and a back surface which receives the head of the wearer.

The visor cap 201 also has two second-type fastening devices 146 and 156 (see FIG. 5) that are attached to the closure band 240. One of the two second-type fastening devices attached to a first end of the closure band, and the other second-type fastening device attached to the second end of the closure band.

The closure band 240 is removably attached to the visor body 202 (i.e. hat body 2) when the first-type fastening devices are mated with the second-type fastening devices. The closure band 240 is configured to be laterally adjustable with respect to the opening of the perimeter portion and to be separable from the hat body 2.

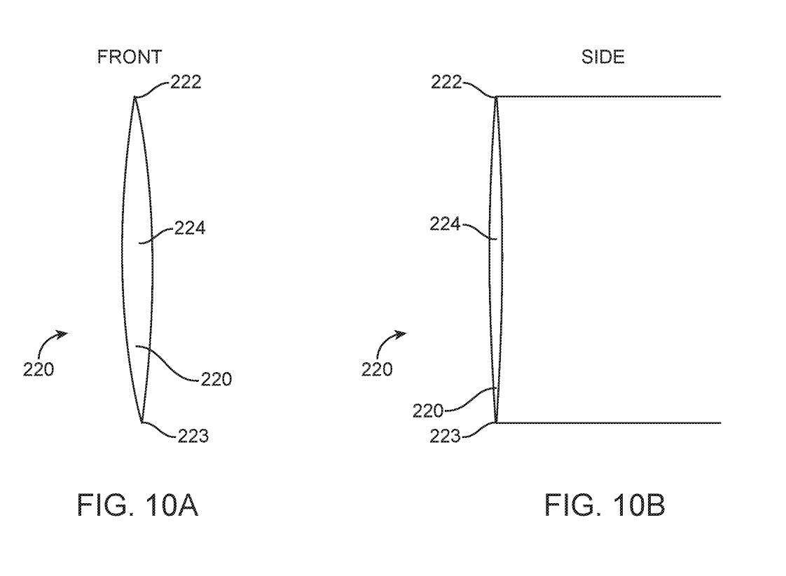

FIGS. 10A and 10B are front and side views respectively of the loop aperture 220. The loop aperture 220 is formed by the stitching 223 along the lower edge 103 of the outer band of mater 203, which defines a cavity 224 that is formed by the stitching of the sweatband 212 to the outer band of material 203. This cavity 224 receives the closure band 240.

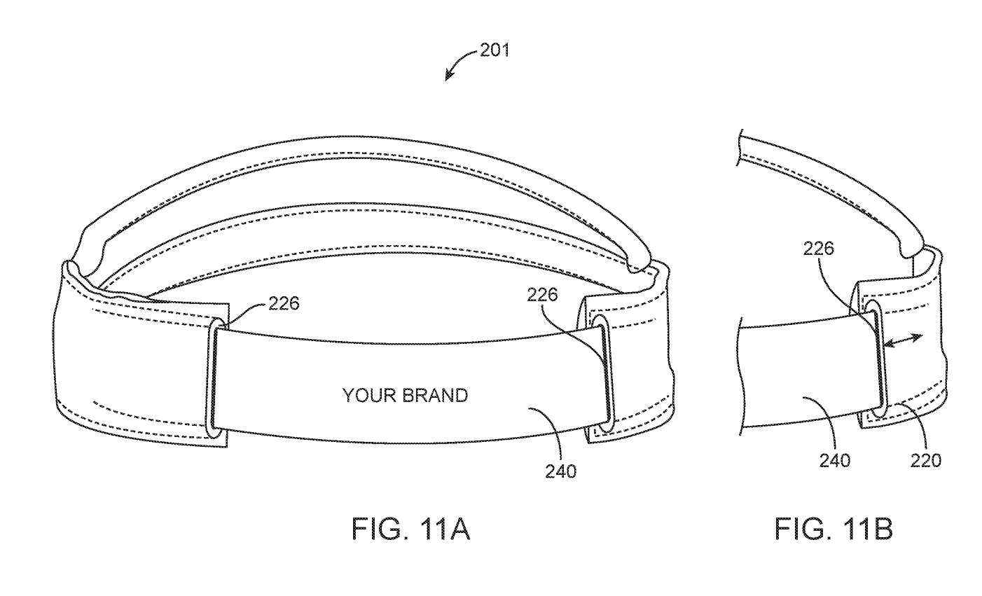

FIG. 11A is a rear view of a visor cap having eyelets, and FIG. 11B is a partial view of the visor cap showing details of the eyelet. The eyelets 226 are mounted to the loop aperture 220 and may reinforce the loop aperture 220. In an embodiment, the closure band 240 is received through the eyelets 226, and may be adjusted laterally to adjust the overall size of the visor cap 201. In one or more embodiments, the eyelets 226 may be formed from plastics or metals. In an embodiment, the eyelets 226 may be distinctly colored, perhaps matching the color of the logo.

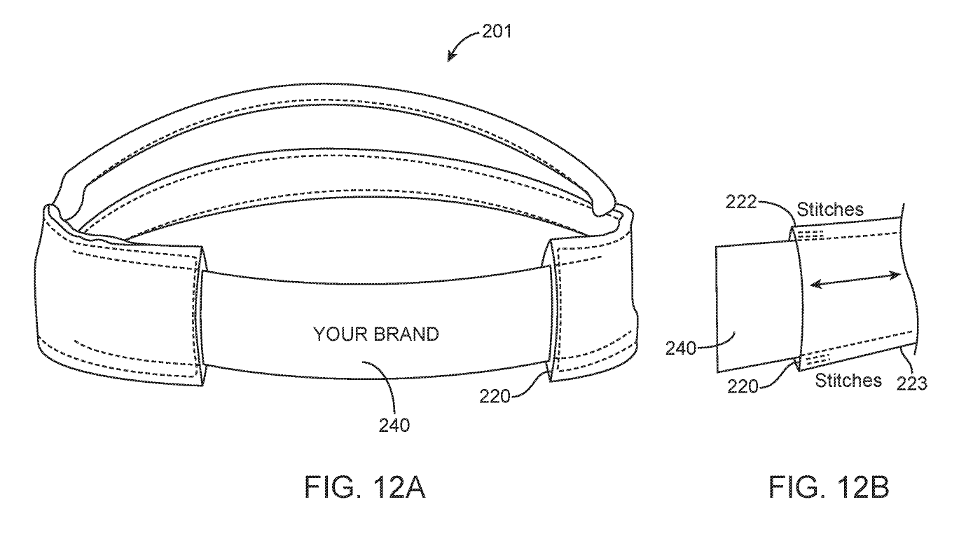

FIG. 12A is a rear view of a visor cap having stitched loop apertures, and FIG. 12B is a partial view of the visor cap 201 showing details of the loop aperture 220. In an embodiment, the closure band 240 is received through the loop aperture 220, and may be adjusted laterally to adjust the overall size of the visor cap 201.

Although the invention has been discussed with reference to specific embodiments, it is apparent and should be understood that the concept can be otherwise embodied to achieve the advantages discussed. The preferred embodiments above have been described primarily as hats such as baseball caps and visor caps with interchangeable and fully adjustable closure bands. In this regard, the foregoing description of the baseball caps is presented for purposes of illustration and description. It shall be apparent that various types of hats or articles of apparel would benefit from having an interchangeable and fully adjustable closure band.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A hat comprising:
a hat body comprising:
a perimeter portion having a lower edge adapted to partially encircle a head of a wearer above the eyes of the wearer, the perimeter portion defining an opening on the back portion of the perimeter portion;
a sweatband positioned in the lower interior of the perimeter portion, the sweatband attached to the perimeter portion near the lower edge of the perimeter portion and at a first distance from the lower edge of the perimeter portion forming two loop apertures on opposite sides of the opening of the perimeter portion, and
two first-type fastening devices affixed to the surface of the sweatband immediately adjacent to the perimeter portion, each of the two first-type fastening devices positioned on opposite sides of the opening of the perimeter portion;
a closure band shaped as an elongated rectangle having a first end and a second end opposite the first end along the length of the closure band, the closure band having a width sized to be received within the loop apertures of the hat body, the closure band having a front surface and a back surface which receives the head of a wearer; and,
two second-type fastening devices attached the closure band, one of the two second-type fastening devices attached to a first end of the closure band, and the other second-type fastening device attached to the second end of the closure band,
wherein the closure band is removably attached to the hat body when the first-type fastening devices are mated with the second-type fastening devices, the closure band configured to be laterally adjustable with respect to the opening of the perimeter portion and to be separable from the hat body.

2. The hat of claim 1, wherein a logo is placed on the closure band.

3. The hat of claim 1, wherein the two second-type fastening devices are affixed to the front surface of closure band.

4. The hat of claim 1, wherein the closure band further comprises a third and fourth second-type fastening devices attached to the closure band on the side opposite the two second-type fastening devices.

5. The hat of claim 1, wherein the hat body further comprises two eyelets each configured to attached to the loop aperture of the hat body and receive the closure band.

6. The hat of claim 1, wherein the first-type and second-type fastening devices comprise hook and loop fasteners.

7. The hat of claim 1, wherein the first-type and second-type fastening devices comprise clip fasteners.

8. The hat of claim 1, wherein the closure band is fabricated from stretchable material.

9. The hat of claim 1, further comprising:
a second closure band sized to be received within the loop apertures of the hat body;
two additional second-type fastening devices attached to the second closure band, one of the two additional second-type fastening devices attached to a first end of the second closure band, and the other additional second-type fastening device attached to a second end of the second closure band,
wherein the second closure band is removably attached to the hat body and is interchangeable with respect to the closure band.

10. The hat of claim 1, wherein the perimeter portion comprises a crown.

11. A hat comprising:
a hat body comprising:
a perimeter portion having a lower edge adapted to partially encircle a head of a wearer above the eyes of the wearer, the perimeter portion defining an opening on the back portion of the perimeter portion;
a sweatband positioned in the lower interior of the perimeter portion, the sweatband attached to the perimeter portion near the lower edge of the perimeter portion and at a first distance from the lower edge of the perimeter portion forming two loop apertures on opposite sides of the opening of the perimeter portion, and
two first-type fastening devices positioned on opposite sides of the opening of the perimeter portion;
a closure band shaped as an elongated rectangle having a first end and a second end opposite the first end along the length of the closure band, the closure band having a width sized to be received within the loop apertures of the hat body; and,
two second-type fastening devices attached the closure band, one of the two second-type fastening devices attached to a first end of the closure band, and the other second-type fastening device attached to the second end of the closure band,
wherein the closure band is removably attached to the hat body when the first-type fastening devices are mated with the second-type fastening devices, the closure band configured to be laterally adjustable with respect to the opening of the perimeter portion and to be separable from the hat body.

12. The hat of claim 11, wherein a logo is placed on the closure band.

13. The hat of claim 11, wherein the closure band further comprises a third and fourth second-type fastening devices attached to the closure band on the side opposite the two second-type fastening devices.

14. The hat of claim 11, wherein the hat body further comprises two eyelets each configured to attached to the loop aperture of the hat body and receive the closure band.

15. The hat of claim 11, wherein the first-type and second-type fastening devices comprise hook and loop fasteners.

16. The hat of claim 11, wherein the first-type and second-type fastening devices comprise clip fasteners.

17. The hat of claim 11, wherein the closure band is fabricated from stretchable material.

18. The hat of claim 11, further comprising: a second closure band sized to be received within the loop apertures of the hat body;
two additional second-type fastening devices attached to the second closure band, one of the two additional second-type fastening devices attached to a first end of the second closure band, and the other additional second-type fastening device attached to a second end of the second closure band,
wherein the second closure band is removably attached to the hat body and is interchangeable with respect to the closure band.

19. A hat comprising:
a hat body comprising:
a perimeter portion having a lower edge adapted to partially encircle a head of a wearer above the eyes of the wearer, the perimeter portion defining an opening on the back portion of the perimeter portion;
two loop apertures formed in the perimeter portion on opposite sides of the opening of the perimeter portion;
two first-type fastening devices positioned in the interior of the perimeter portion positioned on opposite sides of the opening of the perimeter portion;
a closure band shaped as an elongated rectangle having a first end and a second end opposite the first end along the length of the closure band, the closure band having a width sized to be received within the loop apertures of the perimeter portion,
two second-type fastening devices attached the closure band, one of the two second-type fastening devices attached to a first end of the closure band, and the other second-type fastening device attached to the second end of the closure band,
wherein the closure band is removably attached to the hat body when the first-type fastening devices are mated with the second-type fastening devices, the closure band configured to be laterally adjustable with respect to the opening of the hat body and to be separable from the hat body.

20. The hat of claim 19, wherein a logo is placed on the closure band.

21. The hat of claim 19, wherein the closure band further comprises a third and fourth second-type fastening devices attached to the closure band on the side opposite the two second-type fastening devices.

22. The hat of claim 19, wherein the hat body further comprises two eyelets each configured to attached to the loop aperture of the hat body and receive the closure band.

23. The hat of claim 19, wherein the first-type and second-type fastening devices comprise hook and loop fasteners.

24. The hat of claim 19, further comprising: a second closure band sized to be received within the loop apertures of the hat body;
two additional second-type fastening devices attached to the second closure band, one of the two additional second-type fastening devices attached to a first end of the second closure band, and the other additional second-type fastening device attached to a second end of the second closure band,
wherein the second closure band is removably attached to the hat body and is interchangeable with respect to the closure band.
